(19) United States
(12) Patent Application Publication
(10) Pub. No.: US 2025/0196152 A1
(43) Pub. Date: Jun. 19, 2025

(54) IMPACT CRUSHER

(71) Applicant: HAZEMAG & EPR GmBH, Dülmen (DE)

(72) Inventors: Florian Lewe, Dülmen (DE); Christian Kockmann, Coesfeld (DE)

(73) Assignee: HAZEMAG & EPR GmBH, Dülmen (DE)

(21) Appl. No.: 18/980,285

(22) Filed: Dec. 13, 2024

(30) Foreign Application Priority Data
Dec. 14, 2023 (EP) 23216704.9

(51) Int. Cl. B02C 13/06; B02C 13/28

(52) U.S. Cl. CPC B02C 13/06; B02C 13/2804; B02C 2210/02

(57) ABSTRACT

The disclosure relates to an impact crusher having a rotor that has a plurality of rotor disks, wherein each rotor disk has a plurality of edge recesses distributed along its outer circumference. The edge recesses are arranged in alignment with one another and are designed to hold a blow bar. Each edge recess has a first side wall, a second side wall and a bottom wall. A clamping wedge with a clamping wall is arranged on the second side wall of each edge recess. The clamping wedge is fixable to the second side wall in a clamping position in which the clamping wall of the clamping wedge is arranged so as to clamp the blow bar. The clamping wedge is mounted on the second side wall so as to be movable from the clamping position into a maintenance position, in which the clamping wall of the clamping wedge is arranged to release the blow bar.

### BACKGROUND OF THE DISCLOSURE

The invention relates to an impact crusher comprising a rotor that has a plurality of rotor disks, wherein each rotor disk has a plurality of edge recesses distributed along its outer circumference which are designed to extend radially inward from the outer circumference of each rotor disk, the edge recesses of the plurality of rotor disks being arranged in alignment with one another and edge recesses arranged in alignment with one another being designed to hold a blow bar, each edge recess comprising a first side wall, a second side wall and a bottom wall, each edge recess having a retaining part on its first side wall, wherein a clamping wedge with a clamping wall is arranged on the second side wall of each edge recess, and wherein the clamping wedge is fixable to the second side wall in a clamping position in which the clamping wall of the clamping wedge is arranged to clamp the blow bar between itself and the retaining part.

An impact crusher of the aforementioned type is known, for example, from DE 198 13 310 C1. This known impact crusher comprises a rotor which is composed of a plurality of rotor disks. The rotor disks are intersected by edge recesses, which are formed in the outer circumference of the rotor disks and extend radially inward. The edge recesses of all the rotor discs are aligned with one another and form holders for blow bars, wherein one side wall of the edge recesses forms an abutment for the blow bars. The opposite side wall of each edge recess supports a clamping wedge, which is inserted into the edge recess and used to hold the inserted blow bar against the side wall forming the abutment. In the direction of the bottom wall, each rotor disk has a ridge in the region of the side wall, which is provided with a bore, wherein this bore is aligned with a bore in the clamping wedge. A screw connection is inserted through this bore, allowing the clamping wedge to be fastened to the rotor disk. For maintenance of the rotor or impact crusher, the screw connection must be loosened and removed, and the clamping wedge must also be taken out of the edge recess before the inserted blow bar can be removed and repaired or replaced with a new blow bar. For maintenance of a blow bar, it is evident that a plurality of screw connections must be loosened and removed from the rotor body, with the clamping wedges also having to be removed from the rotor body, and therefore maintenance is time-consuming and costly, while also presenting additional hazards due to the weight of the individual parts that need to be removed.

### SUMMARY OF THE DISCLOSURE

The problem addressed by the invention is that of providing a solution which provides an impact crusher in a structurally simple manner in which maintenance of blow bars can be carried out simply, quickly, conveniently and safely. For the purposes of the invention, maintenance is understood to mean the removal of a blow bar from the rotor, either to repair the removed blow bar and then reinstall it or to replace the blow bar and fasten a new blow bar to the rotor.

In an impact crusher of the type described above, the problem is solved according to the invention by the clamping wedge being mounted on the second side wall so as to move from the clamping position to a maintenance position, in which the clamping wall of the clamping wedge is arranged to release the blow bar.

Advantageous and expedient embodiments and developments of the invention can be found in the dependent claims.

The invention provides an impact crusher which is characterized in that each clamping wedge can remain on the rotor disk during maintenance work and does not need to be dismantled. This advantageously enhances safety and offers cost and time savings during rotor maintenance work and in particular during replacement of the blow bars. According to the invention, the clamping wedge is mounted on the second side wall of a recess of each rotor disk in such a way that the clamping wedge can be struck radially downward, sliding downward in a controlled manner along the second side wall, where the clamping wedge can then be pivoted toward the second side wall, allowing said clamping wedge to assume its maintenance position. In the maintenance position of the clamping wedge, there is then sufficient space within the edge recess for the blow bar to be lifted out of the edge recess, while the clamping wedge remains in the rotor body, and in particular on the rotor disk. After the blow bar has been replaced or rotated, the clamping wedges are pivoted back, pushed radially upward, and fixed in the clamping position. In addition, the invention offers a significant ergonomic advantage because the heavy clamping wedges no longer need to be dismantled by maintenance personnel during maintenance work; instead, the clamping wedges remain on the rotor disks, where they are held and movably mounted for maintenance purposes such that a blow bar can be removed from the rotor body.

In one embodiment of the invention, it is particularly advantageous if a positioning device fixes the clamping wedge on the second side wall in the clamping position, wherein the positioning device is designed to hold the clamping wedge on the second side wall during a movement from the clamping position into the maintenance position and to guide its movement relative to the second side wall. According to the invention, this is a mechanical and robust positioning device.

In order to avoid damage to the rotor and hazards for maintenance personnel during maintenance work, the invention provides, in a further embodiment, that the positioning device is designed to guide the movement of the clamping wedge along the second side wall in the direction of the bottom wall as it moves from the clamping position into the maintenance position.

In order to provide a sufficiently large clearance for removing a blow bar, the invention provides, in a further embodiment, that the positioning device pivotally supports the clamping wedge for when it moves in the direction of the second side wall from the clamping position into the maintenance position.

In order to movably mount the clamping wedges at the edge recesses of the rotor disks, a further embodiment of the invention provides that the clamping wedge is formed with two side legs which extend from the clamping wall and run in parallel with one another, wherein the second side wall is arranged between the two side legs and the two side legs each have an opening, the edge of which is formed with a step, and wherein the openings in the two side legs are aligned with one another.

The openings and the steps at the edge of the openings serve to accommodate a mechanical connection, wherein the invention provides in a further embodiment that the positioning device has a first screw connection for this purpose, which extends through the second side wall and the two side legs. In this way, the clamping wedge is connected to the rotor disk.

For movable mounting of the clamping wedges, a further embodiment of the invention provides that each opening in the two side legs is designed as a kind of slotted guide and the first screw connection is designed as a type of sliding block, the first screw connection being loosened for movement out of the clamping position in such a way that, when moving from the clamping position into the maintenance position, the clamping wedge is connected to the second side wall and is movable relative to the second side wall. The screw connection fixedly arranged on the rotor disk thus guides the clamping wedge during its movement from the clamping position into the maintenance position, since the clamping wedge is mounted on the second side wall so as to move relative to the screw connection through the opening, which is designed as a slotted guide.

For a movement of the clamping wedge in the direction of the bottom wall of the edge recess during maintenance work, the invention provides in a further embodiment that the openings in the side legs are each formed with a straight portion which has a predetermined width and which extends from one end face of the clamping wedge to an opposite end face of the clamping wedge, wherein the first screw connection has a guide and lock nut whose square cross section is adapted to the predetermined width of the opening. The square cross section of the nut has the advantage of precise guidance of the clamping wedge and makes work easier, since no tools are required to lock the first screw connection when loosening and tightening it.

In an embodiment of the invention, it is particularly advantageous if, during maintenance work, the first screw connection, which is in a loosened state, forms a pivot axis about which the clamping wedge is pivotally mounted for when it moves into the maintenance position.

In order to securely and permanently fasten the clamping wedges in the clamping position, the invention provides in one embodiment that the positioning device comprises a second screw connection which extends through the second side wall and the two side legs, wherein, a first through-hole and a second through-hole arranged at a radial distance from the first through-hole are formed through the second side wall in an axial direction, the first through-hole accommodating the first screw connection and, when viewed in a radial direction, the first through-hole being arranged between the bottom wall and the second through-hole.

In order to securely fasten the clamping wedge in the clamping position, the invention provides in one embodiment that, in the clamping position, the second through-hole accommodates the second screw connection, and the first screw connection and the second screw connection each form tightly fastened connections such that the clamping wedge is fixedly held on the second side wall. In particular, the fixedly held clamping wedge clamps the blow bar firmly between itself and the retaining part in the clamping position.

Finally, in one embodiment of the invention, it is provided that the second screw connection has a lock nut or a T-nut, the cross section of which is adapted to the predetermined width or step of the opening. The cross section of the nut has the advantages of providing precise guidance for the clamping wedge, making it easier to loosen and tighten the first screw connection by eliminating the need for a locking tool, and fastening the clamping wedge in the clamping position in a more stable and secure manner.

It goes without saying that the features mentioned above and those to be explained below can be used not only in the specified combination, but also in other combinations or in isolation, without departing from the scope of the present invention. The scope of the invention is defined only by the claims.

### BRIEF DESCRIPTION OF THE DRAWINGS

Other specifics, features and advantages of the invention will emerge from the following description in context with the drawing, in which a preferred embodiment of the invention is presented. In the drawing:

FIG. 1 is a perspective view of an impact crusher according to the invention,

FIG. 2 is a side view of the impact crusher according to the invention,

FIG. 3 is a perspective detailed view of the impact crusher according to the invention,

FIG. 4 is a further perspective detailed view of the impact crusher according to the invention,

FIG. 5 is a further perspective detailed view of the impact crusher according to the invention,

FIG. 6 is a perspective view of an edge recess of a rotor disk and a clamping wedge of the impact crusher according to the invention,

FIG. 7 is a perspective view of the clamping wedge and part of a positioning device,

FIG. 8 is another perspective view of the clamping wedge and the part of the positioning device,

FIG. 9 is a perspective detailed view of the clamping wedge in a clamping position,

FIG. 10 is a perspective detailed view of the clamping wedge when moving from the clamping position toward a maintenance position,

FIG. 11 is a perspective detailed view of the clamping wedge when moving toward the maintenance position, and

FIG. 12 is a perspective detailed view of the clamping wedge in the maintenance position.

### DETAILED DESCRIPTION OF THE DISCLOSURE

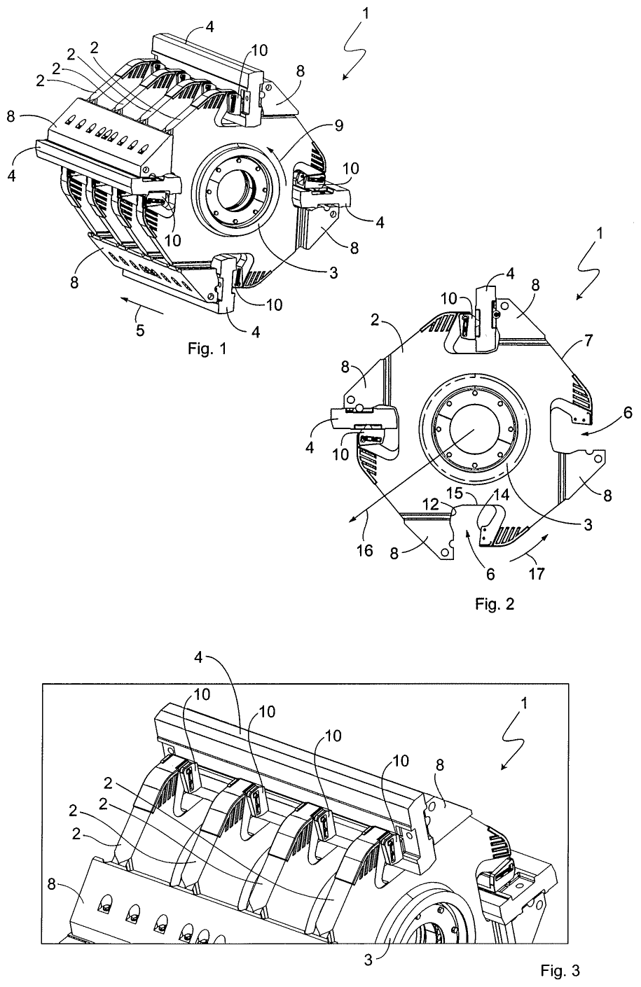

FIGS. 1 to 3 show different views of a rotor 1, which is part of an impact crusher. The rotor 1 comprises a plurality of rotor disks 2, there being a total of four rotor disks 2 in the embodiment shown. The rotor disks 2 are non-rotatably fastened to a rotor body 3. Around the outer circumference of the rotor disks 2, blow bars 4 are fastened to the rotor disks 2 at uniform circumferential intervals, wherein each blow bar 4 extends in an axial direction 5 with respect to the rotor body 3 and across the rotor disks 2. In the embodiment shown, the rotor 1 comprises a total of four blow bars 4. For the sake of greater clarity, only two blow bars 4 are shown in FIG. 2 in order to make edge recesses 6 more visible. The blow bars 4 are inserted into edge recesses 6 in the rotor disks 2 where they are fastened. Accordingly, each rotor disk 2 comprises a plurality of edge recesses 6 distributed along its outer circumference 7, which are designed to extend radially inward from the outer circumference 7 of each rotor disk 2. In total, with reference to the embodiment shown, four edge recesses 6 are formed in each rotor disk 2 for fastening the four blow bars 4. The edge recesses 6 of the plurality of rotor disks 2 are arranged in alignment with one another, wherein aligned edge recesses 6 are designed to hold a blow bar 4. Each blow bar 4 is supported on a retaining part 8, with the support being provided on the rear side of the blow bar 4, which faces away from the direction of rotation or rotor direction of circulation 9 of the rotor 1 that prevails during operation.

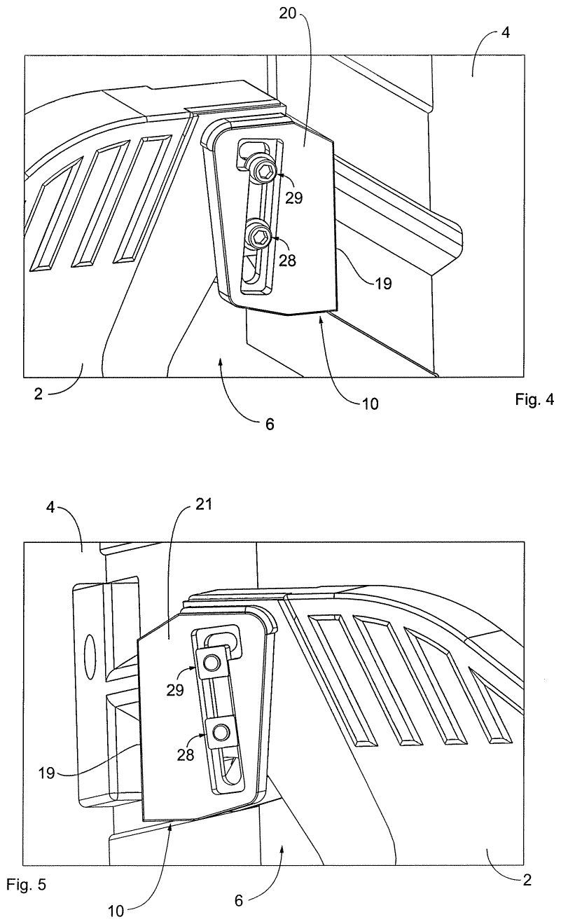

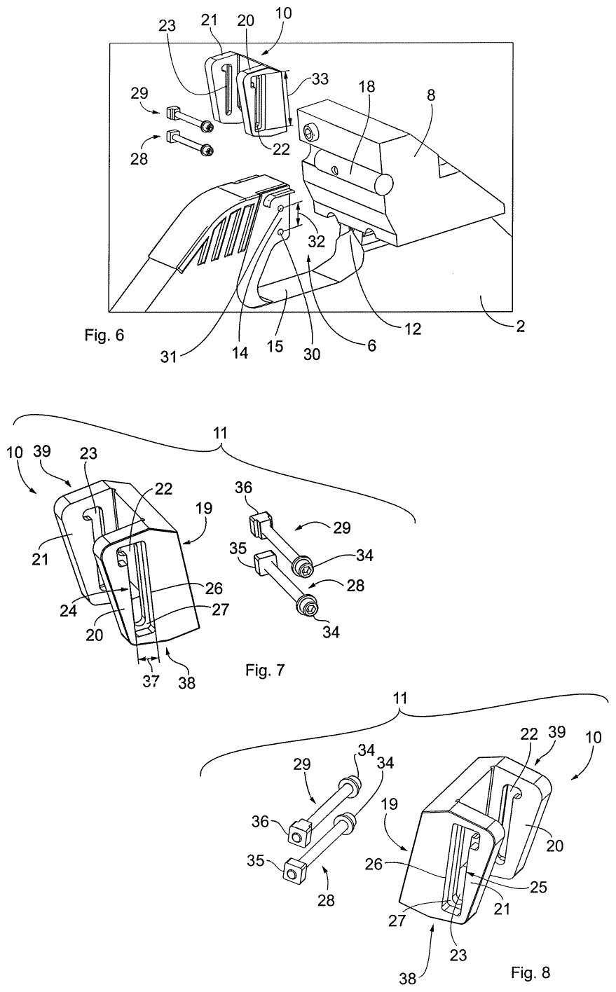

FIGS. 4 to 6 show detailed views of a single edge recess 6 of a single rotor disk 2, FIG. 4 showing a front view of the rotor disk 2 and FIG. 5 showing a rear view of the same rotor disk 2, whereas FIG. 6 shows the individual parts of the front view. As FIGS. 4 and 5 show, a clamping wedge 10 is provided for fastening the blow bar 4, which wedge is arranged within the edge recess 6, wherein the particular blow bar 4 is arranged so as to be clamped between the clamping wedge 10 and the retaining part 8 when the clamping wedge 10 is in a clamping position. The clamping position of each clamping wedge 10 is shown in FIGS. 1 to 5. From the view in FIG. 6 of the individual parts, it can be seen that the edge recess 6 comprises a first side wall 12, a second side wall 14, which is opposite the first side wall 12, and a bottom wall 15. The circumferential extent of the edge recess 6 increases in in a radial direction 16 and in the direction of the rotor body 3 so that in the region of the bottom wall 15, the edge recess 6 is larger when viewed in the circumferential direction 16 than on the outer circumference 7 of the rotor disk 2. The first side wall 12 of the edge recess 6 comprises the retaining part 8, which in the illustrated embodiment is fastened to the rotor disk 2, or alternatively can also be formed by the rotor disk 2 itself. Each blow bar 4 has, on its side facing the retaining part 8, a groove extending in the axial direction 5, into which groove a retention bar 18 is inserted, which is fastened in a recess in the retaining part 8. The retention bar 18 holds the clamped blow bar 4 in position and prevents the blow bar 5 from moving in the radial direction 16 during operation.

FIGS. 4 and 5 show the clamping wedge 10 in its clamping position, whereas FIGS. 6 to 8 show various views of the individual parts, which will be discussed below. A clamping wedge 10 is mounted on every second side wall 14 of each edge recess 6. In the clamping position, the clamping wedge 10 is fastened to the second side wall 14, wherein, in the clamping position, a clamping wall 19 of the clamping wedge 10 rests against the blow bar 4 so that the blow bar 4 is clamped between the clamping wall 19 of the clamping wedge 10 and the retaining part 8. Consequently, in the clamping position, the clamping wall 10 of the clamping wedge 10 is arranged so as to clamp the blow bar 4 between itself and the retaining part 8. According to the invention, the clamping wedge 10 is mounted on the second side wall 14 so as to be movable from the clamping position into a maintenance position, wherein, in the maintenance position, the clamping wall 19 of the clamping wedge 10 is arranged to release the blow bar 4, as is shown, for example, in FIG. 12 and described in more detail below. The clamping wedge 10 is fixed in its clamping position by means of a positioning device 11. The positioning device 11 fixes the clamping wedge 10 in the clamping position on the second side wall 14 (see, for example, FIGS. 1 to 5 and 9), the positioning device 11 being designed to hold the clamping wedge 10 on the second side wall 14 during a movement from the clamping position into the maintenance position and to guide its movement relative to the second side wall 14. The movement between the clamping position and the maintenance position is shown in FIGS. 10 and 11, while FIG. 12 shows the maintenance position of the clamping wedge 10. The positioning device 11 is further designed to guide the movement of the clamping wedge 10 along the second side wall 14 in the direction of the bottom wall 15 as it moves from the clamping position into the maintenance position (see, for example, FIGS. 10 and 11). Finally, the positioning device 11 pivotally supports the clamping wedge 10 during its movement from the clamping position into the maintenance position in the direction of the second side wall 14.

FIGS. 6 to 8 show further details of the structural design of the clamping wedge 10. As can be seen, the clamping wedge 10 is designed having two side legs 20 and 21. The two side legs 20 and 21 extend from the clamping wall 19 and run in parallel with one another. The two side legs 20 and 21 engage around the second side wall 14 (see also, for example, FIGS. 4 and 5 in this respect), so that the second side wall 14 is arranged between the two side legs 20 and 21. Furthermore, the two side legs 20 and 21 each have an opening 22 and 23. The openings 22 and 23 each have a straight portion 24 and 25. The straight portions 24 and 25 are aligned with one another. The straight portions 24 and 25 extend from an end face 38 of the clamping wedge 10 to an opposite end face 39 of the clamping wedge 10. Furthermore, an edge 26 of the openings 22 and 23 is formed in each case having a step 27.

The positioning device 11 is configured by a first screw connection 28 when the clamping wedge 10 moves from the clamping position into the maintenance position. Furthermore, the positioning device 11 is configured by the first screw connection 28 and a second screw connection 29 in the clamping position. In both the clamping and maintenance positions, a clamping wedge 10, together with its openings 22 and 23 formed in the side legs 20 and 21, forms part of the positioning device 11. The first screw connection 289 and the second screw connection 29 can be seen, for example, from FIGS. 6 to 8. Both the first screw connection 28 and the second screw connection 29 extend through the second side wall 14 and through the two side legs 20 and 21 in each case. In particular, the first screw connection 28 and the second screw connection 29 extend through the openings 22 and 23 in the two side legs 20 and 21. As shown in FIG. 6, a first through-hole 30 and a second through-hole 31 are formed in the second side wall 14, which serve to accommodate the first and second screw connections 28 and 29, respectively. The first through-hole 30 and the second through-hole 31 extend in the axial direction 5 through the second side wall 14. FIG. 6 shows that the second through-hole 31 is arranged at a radial distance 32 from the first through-hole 30. The radial distance 32 is smaller than a radial extension 33 of each of the straight portions 24, 25 of the two openings 22, 23 in the two side legs 20, 21. Viewed in the radial direction 16, the first through-hole 30 is arranged between the bottom wall 15 and the second through-hole 31.

According to the above statements, during a movement from the clamping position to the maintenance position, the positioning device 11 only comprises the first screw connection 28, whereas, in the clamping position, the positioning device 11 comprises both the first screw connection 28 and the second screw connection 29. The first screw connection 28 extends through the first through-hole 30 and the second screw connection 29 extends through the second through-hole 31. As a result, the first screw connection 28 and the second screw connection 29 are fixedly positioned on the second side wall 14.

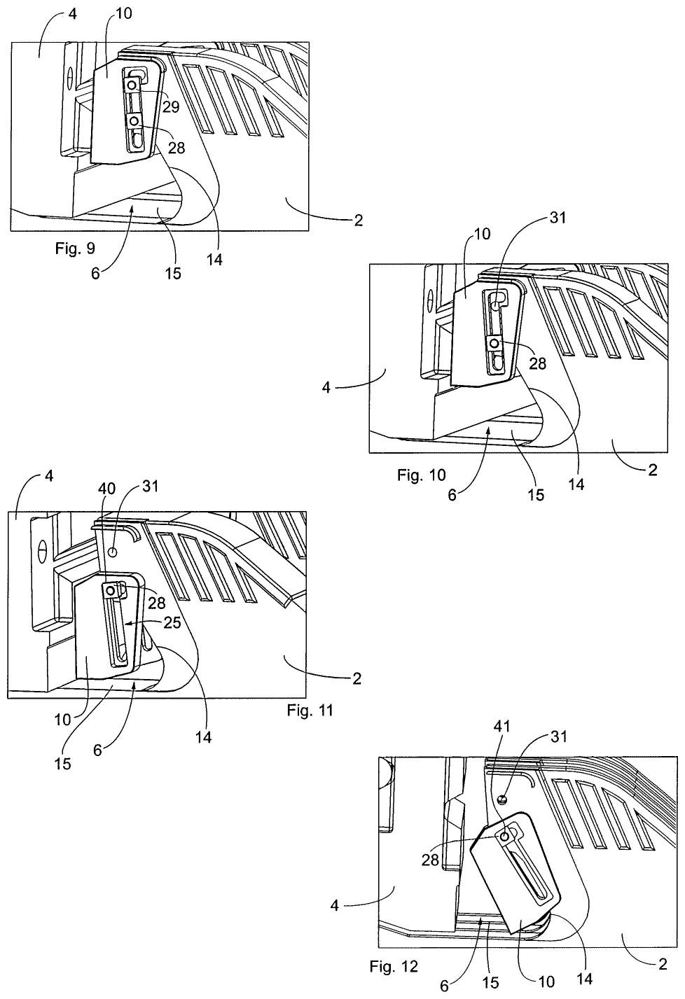

FIGS. 9 to 12 schematically show individual steps for removing a blow bar 4. FIG. 9 shows the clamping wedge 10 in its clamping position, in which the clamping wedge 10 clamps the blow bar between itself and the retaining part 8. In the clamping position, the first screw connection 28 and the second screw connection 29 each form tightly fastened connections such that the clamping wedge 10 is fixedly held on the second side wall 14. For the purposes of the invention, a tightly fastened connection is understood to mean a screw connection in which, for example, a predetermined torque is exerted during tightening, ensuring that the clamping wedge 10 is immovably fixed in its clamping position on the second side wall 14 by means of the first screw connection and the second screw connection, each of which are tightly fastened. In the clamping position, which is also shown in FIGS. 4 and 5, the first screw connection 29 and the second screw connection 30 are supported on the step 27 of the associated openings 22 and 23 formed in the side legs 20, 21. More precisely, a screw head 34 and a nut 35 and 36 rest on the step 27. The nut 35 of the first screw connection 28 is designed as a guide and lock nut, the square cross section of which is adapted to a predetermined width 37 of the opening 22. The nut 36 of the second screw connection 29 can also be configured as a lock nut, wherein, in the illustrated embodiment, the nut 36 is configured as a T-nut whose cross section is adapted to the predetermined width 37 of the opening 23 and to the cross section of the step 27 of the opening 23. The square cross section of the nuts 35 and 36 has the advantage that no locking tool is required in order to loosen or release (but also to tighten) the first screw connection 28 and the second screw connection 29, and that the nuts 35, 36 are each supported on the stepped edge 26 or the corresponding step 27. For maintenance of each blow bar 4, the second screw connection 29 is loosened and removed, while the first screw connection 28 remains merely in a loosened state. This is shown in FIG. 10, in which the second screw connection 29 is removed and dismantled from the clamping part 10 and the second side wall 14. Within the context of the invention, a loosened state is understood to mean that the first screw connection 28 is no longer tightened with a predetermined torque, and therefore the first screw connection 28 is held on the second side wall 14 but does not fix the clamping wedge 10 in the clamping position, thereby allowing a movement of the clamping wedge 10 relative to the first screw connection 28 and thus to the second side wall 14.

A relative movement of the clamping wedge 10 with respect to the first screw connection 28 and thus to the second side wall 14 is possible because the openings 22 and 23 in the two side legs 20, 21 are designed as a type of slotted guide, and the first screw connection 28 is designed as a type of sliding block. This relative movement can be seen in FIG. 11 by comparison with FIG. 10. Since the first screw connection 28 is loosened to allow for movement out of the clamping position, the clamping wedge 10 remains connected to the second side wall 14 and can be moved relative to the second side wall 14 during a movement from the clamping position into the maintenance position. The combination of the slotted guide and the sliding block enables the clamping wedge 10 to move relative to the second side wall 14 in the direction of the bottom wall 15, FIG. 11 showing a position of the clamping wedge 10 in which the clamping wedge is displaced in the direction of the bottom wall 15, wherein the first screw connection 28 in the corresponding straight portions 24, 25 of the openings 22, 23 is moved radially outward when viewed with respect to the openings 22, 23. This radial displacement of the clamping wedge 10 in the direction of the bottom wall 15 ends when the first screw connection 28 has reached a longitudinal end 40 of the straight portions 24, 25, as shown in FIG. 11. The first screw connection 28, which is in the loosened state when the clamping wedge 10 moves from the clamping position into the maintenance position, furthermore forms a pivot axis 41 (see, for example, FIG. 12) about which the clamping wedge 10 is pivotally mounted for when it moves into the maintenance position. By means of this pivot axis 41, the clamping wedge 10 can be pivoted from the position shown in FIG. 11 in the direction of the second side wall 14 and is pivoted in the direction of the second side wall 14 to reach the maintenance position, as shown in FIG. 12 and in which the clamping wedge 10 assumes the maintenance position. In the maintenance position, the clamping wall 19 of the clamping wedge 10 is arranged to release the blow bar 4, and the clamping wedge 10 remains held on the second side wall 14 so that the clamping wedge 10 remains on the second side wall 14 for the purpose of removing the blow bar 4 and does not have to be dismantled. In order to facilitate the removal or the dismantlement of the blow bar 4, in a non-disclosed embodiment, the clamping wedge 10 can be locked in the maintenance position by the clamping wedge 10 being fixed in the maintenance position by means of an additional screw connection together with the first screw connection 28 on the second side wall 14.

In summary, the present invention relates to a blow bar locking mechanism in the rotor body, in which the clamping wedge 10 and the second side wall 14 of each rotor disk 2 are specially configured. Each clamping wedge 10 is designed, with its clamping wall 19 and its side legs 20, 21, to correspond to the contour of the rotor disk 2 in such a way that the clamping wedge 10 can be struck downward, i.e. radially inward in the direction of the bottom wall 15 of an edge recess 6, after the second screw connection 29 has been removed. According to preferred embodiments, the clamping wedge 10 slides in a controlled manner toward the bottom wall 15 by means of the first screw connection 28 and the straight portions 24, 25 of the openings 22, 23 and is then pivoted in this lower end position toward the second side wall 14 of the rotor disk 2 so that the clamping wedge 10 is arranged in the maintenance position. This particular kinematics of the clamping wedge 10 provides sufficient space in the maintenance position for the blow bar 4 to be lifted out of the edge recess 6, while the clamping wedge 10 remains on the rotor disk 2. After the blow bar 4 has been replaced or rotated, the clamping wedges 10 are pivoted back again, pushed upward and fixed in the locked clamping position by the first screw connection 28 and the second screw connection 29, ready for operation again. Consequently, according to the invention the clamping wedge 10 can remain on the rotor disk 2 for maintenance purposes.

Of course, the invention described above is not limited to the described and illustrated embodiment. It can be seen that numerous modifications can be made to the embodiment depicted in the drawing, which are obvious to a person skilled in the art according to the intended application, without leaving the scope of the invention. The invention includes everything that is contained in the description and/or shown in the drawing, including anything that, deviating from the specific embodiment, is obvious to a person skilled in the art.

### LIST OF REFERENCE SIGNS

1 rotor
2 rotor disk
3 rotor body
4 blow bar
5 axial direction
6 edge recesses
7 outer circumference
8 retaining part
9 rotor direction of circulation
10 clamping wedge
11 positioning device
12 first side wall
14 second side wall
15 bottom wall
16 radial direction
17 circumferential direction
18 retention bar
19 clamping wall
20 side leg
21 side leg
22 opening to 20
23 opening to 21
24 straight portion
25 straight portion
26 edge
27 step
28 first screw connection
29 second screw connection
30 first through-hole
31 second through-hole
32 radial distance
33 radial extension
34 screw head
35 nut of 28
36 nut of 29
37 predetermined width of 22
38 end face
39 end face
40 longitudinal end of 24 and 25
41 pivot axis 33

1. An impact crusher comprising a rotor that has a plurality of rotor disks, each rotor disk having a plurality of edge recesses distributed along its outer circumference, which are designed to extend radially inward from the outer circumference of each rotor disk, the edge recesses of the plurality of rotor disks being arranged in alignment with one another, edge recesses arranged in alignment with one another being designed to hold a blow bar, each edge recess comprising a first side wall, a second side wall and a bottom wall, each edge recess having a retaining part on its first side wall, a clamping wedge with a clamping wall being arranged on the second side wall of each edge recess, and the clamping wedge being fixable to the second side wall in a clamping position in which the clamping wall of the clamping wedge is arranged to clamp the blow bar between itself and the retaining part,
wherein
the clamping wedge is mounted on the second side wall so as to be movable from the clamping position into a maintenance position, in which the clamping wall of the clamping wedge is arranged to release the blow bar.

2. The impact crusher according to claim 1, wherein a positioning device fixes the clamping wedge in the clamping position to the second side wall, the positioning device being designed to hold the clamping wedge on the second side wall during a movement from the clamping position into the maintenance position and to guide its movement relative to the second side wall.

3. The impact crusher according to either claim 1 wherein the positioning device is designed to guide the movement of clamping wedge along the second side wall in the direction of the bottom wall during its movement from the clamping position into the maintenance position.

4. The impact crusher according to claim 1 wherein the positioning device pivotally supports the clamping wedge for when it moves in the direction of the second side wall from the clamping position into the maintenance position.

5. The impact crusher according to claim 2 wherein the clamping wedge is formed having two side legs which extend from the clamping wall and run in parallel with one another, the second side wall being arranged between the two side legs and the two side legs each having an opening, the edge of which is formed with a step, and the openings in the two side legs being aligned with one another.

6. The impact crusher according to claim 5, wherein the positioning device comprises a first screw connection which extends through the second side wall and the two side legs.

7. The impact crusher according to claim 6, wherein each opening in the two side legs is designed as a type of slotted guide and the first screw connection is designed as a type of sliding block, the first screw connection being loosened for movement out of the clamping position such that, when moving from the clamping position into the maintenance position, the clamping wedge is connected to the second side wall and is movable relative to the second side wall.

8. The impact crusher according to claim 6 wherein the openings in the side legs are each formed having a straight portion which has a predetermined width and which extends from an end face of the clamping wedge to an opposite end face of the clamping wedge, the first screw connection having a guide and lock nut whose square cross section is adapted to the predetermined width of the opening.

9. The impact crusher according to claim 6 wherein the first screw connection, which is in a loosened state, forms a pivot axis about which the clamping wedge is pivotally mounted for when it moves into the maintenance position.

10. The impact crusher according to claim 6, wherein the positioning device has a second screw connection which extends through the second side wall and the two side legs, a first through-hole and a second through-hole arranged at a radial distance from the first through-hole being formed through the second side wall in an axial direction, the first through-hole accommodating the first screw connection and, when viewed in a radial direction, the first through-hole being arranged between the bottom wall and the second through-hole.

11. The impact crusher according to claim 10, wherein the clamping position, the second through-hole accommodates the second screw connection and the first screw connection and the second screw connection each form tightly fastened connections such that the clamping wedge is fixedly held on the second side wall.

12. The impact crusher according to claim 10 wherein the second screw connection has a lock nut or a T-nut, the cross section of which is adapted to the predetermined width or step of the opening.
